(19) United States
(12) Patent Application Publication
(10) Pub. No.: US 2013/0021921 A1
(43) Pub. Date: Jan. 24, 2013

(54) METHOD AND APPARATUS FOR TRANSMITTING UPLINK CONTROL INFORMATION

(71) Applicants: Hong He, Beijing (CN); Yingyang Li, Beijing (CN); Chengjun Sun, Beijing (CN)

(72) Inventors: Hong He, Beijing (CN); Yingyang Li, Beijing (CN); Chengjun Sun, Beijing (CN)

(73) Assignee: Samsung Electronics Co., Ltd., Gyeonggi-do (KR)

(21) Appl. No.: 13/639,085

(22) PCT Filed: Apr. 1, 2011
(86) PCT No.: PCT/KR11/02278

§ 371 Date: Oct. 2, 2012

(30) Foreign Application Priority Data
Apr. 2, 2010 (CN) 201010144678.9

(51) Int. Cl. H04W 72/04; H04W 52/02; H04W 24/00

(52) U.S. Cl. 370/242; 370/329; 370/311

(57) ABSTRACT

A method for transmitting uplink control information includes: determining, by a User Equipment (UE), configuration information of its Component Carrier (CC); receiving, by UE, a downlink data packet of each CC, and generating acknowledgement/negative acknowledgement ACK/NACK information of the CC to be fed back for each CC independently; and determining indicator information for indicating the ACK/NACK information of the UE that is to be fed back to an evolved Node-B eNB and a channel resource for sending the indicator information according to the configuration information of its CC and whether it is required to send a Scheduling Requirement (SR) information, and sending an indicator message using the determined channel resource.

### TECHNICAL FIELD

The present invention relates to mobile communication technologies, and particularly to a method for transmitting uplink control information.

### BACKGROUND ART

At present, in a Long Term Evolution (LTE) system, uplink control information mainly includes acknowledgement/negative acknowledgement (ACK/NACK) information for a downlink data packet, Channel Quality Indicator (CQI) information, a Rank indicator (RI) for downlink Multiple Input Multiple Output (MIMO) feedback, a Pre-coding Matrix Indicator (PMI), and a resource Scheduling Requirement (SR) for uplink transmission, etc. Specifically, in the LTE system, a structure for an SR channel of an uplink control channel is as shown in FIG. 1. The structure of that channel is identical to that of an uplink ACK/NACK control channel (as shown in FIG. 2), where both employ various cyclic shifted and time-domain orthogonal code cover extended two-dimensional orthogonal channel structure based on a Constant Amplitude Zero Auto Correlation (CAZAC) sequence. In the LTE system, a fixed SR resource is allocated to each User Equipment (UE) for sending an uplink resource requirement by using a static configuration method, and each SR instruction is sent by using an On-Off Keying (OOK) method. When the UE requires to apply for new uplink resource scheduling, within a configured SR sub-frame, the UE sends an SR having a modulation symbol of d(0)=1, for requesting a new uplink data resource scheduling. In this case, the SR being sent is called a positive SR. On the other hand, when there is no scheduling requirement for the UE, no information is sent on the allocated SR channel. In this case, it is called a negative SR. In order to ensure a Constant Modulus (CM) characteristic of an uplink signal, it is specified in the LTE system that when an SR is located in the same sub-frame as the ACK/NACK, for the positive SR, the UE sends the ACK/NACK information on the SR channel having been allocated, and for the negative SR, the UE sends the ACK/NACK on the ACK/NACK channel having been allocated.

In order to improve a peak data rate of the whole system, in an LTE-Advance (LTE-A) system, a carrier aggregation method is employed to implement a configurable system bandwidth in the prior art. Each carrier unit is called a Component Carrier (CC). The UE in the LTE-A system can operate normally on every CC. A structure of a radio frame of the LTE-A system is as shown in FIG. 3 and FIG. 4. Specifically, the system bandwidth has a maximum value of 100 MHz, and the system bandwidth is composed of five CCs and each CC has a maximum bandwidth of 20 MHz. Considering division for existing radio frequency spectrum, in a recent meeting by the 3GPP RAN4 working group, operators of the LTE-A system allocates the CC configured for the future LTE-A system onto two distinct frequency bands. A specific allocation manner is as shown in FIG. 4, which generally includes two schemes:

[4] a. One CC is configured on a band, and 2, 3 or 4 CCs are configured on another band, so that the quantity of the CC configured on the two bands is in a proportion of 1:2, 1:3 or 1:4; and

[5] b. Two CCs are configured on a band, and 2 or 3 CCs are configured on another band, so that the quantity of the CC c configured on the two bands is in a proportion of 2:2 or 2:3.

In order to reduce complexity of the UE in the LTE-A system, the 3GPP RAN1 specifies in the LTE-A specification that in the LTE-A system, when multiple downlink or uplink CCs are configured for the UE, the SR and the CQI instruction are all sent on the same CC, and meanwhile, the ACK/NACK information of downlink data packets of distinct CCs are also collected on a certain CC for sending. Considering that the low CM characteristic of a single uplink CC transmission is important to ensure a reception performance for the uplink control information, how to feed back the ACK/NACK information as much as possible through the SR channel to an evolved Node-B (eNB) with an uplink CM being reduced as much as possible has become an issue to be discussed and solved in the future by the 3GPP RANI standardization organization.

### DISCLOSURE OF INVENTION

### Solution to Problem

The present invention provides a method for transmitting uplink control information, which can feed back the ACK/NACK information of each CC through the SR channel to the eNB in the case that multiple CCs are configured for the UE, thereby improving frequency spectrum efficiency and downlink throughput of the whole system.

In order to achieve the above object, the technical solutions of the present invention are implemented as follows.

A method for transmitting uplink control information, which includes:

determining, by User Equipment UE, configuration information of its Component Carrier CC;

receiving, by UE, a downlink data packet of each CC, and generating acknowledgement/negative acknowledgement ACK/NACK information of the CC to be fed back for each CC independently; and

determining indicator information for indicating the ACK/NACK information of the UE that is to be fed back to an evolved Node-B eNB and a channel resource for sending the indicator information according to the configuration information of its CC and whether it is required to send a SR information, and sending an indicator message using the determined channel resource.

The process of determining, by UE, configuration information of its CC includes:

receiving, by the UE, system information broadcasted in its cell or radio resource control signaling sent from the eNB to determine the configuration information of its CC, wherein the configuration information includes at least information of a band that each CC is located and a serial number of each CC in the band.

The process of receiving, by UE, a downlink data packet of each CC, and generating ACK/NACK information of the CC to be fed back for each CC independently includes:

making the downlink data packet sent on each CC within a current sub-frame to contain one or two code words, and determining, by the UE, the ACK/NACK information of the CC to be fed back according to a reception state of all of the code word.

The process of determining, by the UE, the ACK/NACK information of the CC to be fed back according to a reception state of all of the code word includes:

setting the ACK/NACK information to be fed back as ACK if the UE receives all of the code words successfully, setting the ACK/NACK information to be fed back as DTX if no downlink data packet sending is detected, and setting the ACK/NACK information to be fed back as NACK if reception of any code word of the downlink data packets is failed.

The process of determining indicator information for indicating the ACK/NACK information of the UE that is to be fed back to an eNB and a channel resource for sending the indicator information according to the configuration information of its CC and whether it is required to send a SR information, and sending an indicator message using the determined channel resource includes:

coding and mapping, by the UE, the ACK/NACK information of each CC to be fed back as two-bit indicator information according to the configuration information of the CC and in accordance with a predetermined mapping rule and modulating the two-bit indicator information onto an SR channel for sending, if within a current sub-frame, the UE needs to send a positive SR while feeding back the ACK/NACK information of each CC; or

mapping, by the UE, the ACK/NACK information to be fed back onto an ACK/NACK channel resource for sending, if otherwise.

The process of coding and mapping, by the UE, the ACK/NACK information of each CC to be fed back as two-bit indicator information according to the configuration information of the CC and in accordance with a predetermined mapping rule includes:

dividing all of the possible ACK/NACK information of the UE to be fed back into four distinct state sets according to the configuration information of the CC, and establishing a one-to-one correspondence relationship between the four state sets and four combinations related to the two-bit indicator information; and

determining the ACK/NACK information of the UE of this sub-frame to be fed back and the state set that it is located according to the generated ACK/NACK information of each CC of this sub-frame, and determining the two-bit indicator information for indicating the ACK/NACK information of the UE according to the correspondence relationship.

The process of dividing all of the possible ACK/NACK information of the UE to be fed back into four distinct state sets according to the configuration information of the CC includes:

dividing all of the possible ACK/NACK information of the UE to be fed back into the four distinct state sets {state₁, state₂} in a way as follows, when the CC allocated for the UE is located at two distinct bands and a quantity of the CC of at least CCs number of one band is 1, wherein state, represents the ACK/NACK information of the band containing only one CC among the two bands to be fed back and state₂ represents the ACK/NACK information of the other band to be fed back:

state set 0: {DTX, *};

state set 1: {NACK, *};

state set 2: {ACK, DTX};

state set 3: {ACK, **};

wherein a state symbol “NACK” represents that reception of the downlink data packet of at least one CC within the band is failed, the state symbol “*” represents that the ACK/NACK information to be fed back is arbitrary, and the state symbol “**” represents that at least the first downlink data packet is received successfully on the band.

The process of dividing all of the possible ACK/NACK information of the UE to be fed back into four distinct state sets according to the configuration information of the CC includes:

dividing all of the possible ACK/NACK information of the UE to be fed back into the four distinct state sets{state₁, state₂} in a way as follows, when the CC allocated for the UE is located at two distinct bands and a quantity of the CC of at least one band is 1, wherein state, represents the ACK/NACK information of the band containing only one CC among the two bands to be fed back and state, represents the ACK/NACK information of the other band to be fed back:

state set 0: {DTX, *};

state set 1: {ACK, *};

state set 2: {NACK, DTX};

state set 3: {NACK, **};

wherein a state symbol “NACK” represents that reception of the downlink data packet of at least one CC within the band is failed, the state symbol “*” represents that the ACK/NACK information to be fed back is arbitrary, and the state symbol “**” represents that at least the first downlink data packet is received successfully on the band.

The process of dividing all of the possible ACK/NACK information of the UE to be fed back into four distinct state sets according to the configuration information of the CC includes:

dividing all of the possible ACK/NACK information of the UE to be fed back into the four distinct state sets {state₁, state₂} in a way as follows, when the CC allocated for the UE is located at two distinct bands and a quantity of the CC of at least one band is 1, wherein state, represents the ACK/NACK information of the band containing only one CC among the two bands to be fed back and state₂ represents the ACK/NACK information of the other band to be fed back:

state set 0: {DTX, DTX };

state set 1: {ACK, *};

state set 2: {NACK, *};

state set 3: {DTX, **};

wherein a state symbol “NACK” represents that reception of the downlink data packet of at least one CC within the band is failed, the state symbol “*” represents that the ACK/NACK information to be fed back is arbitrary, and the state symbol “*” represents that at least the first downlink data packet is received successfully on the band.

The process of dividing all of the possible ACK/NACK information of the UE to be fed back into four distinct state sets according to the configuration information of the CC includes:

using a single-band ACK/NACK feedback method to feed back the ACK/NACK information of the band containing multiple CCs, when the CC allocated for the UE is located at two distinct bands and a quantity of the CC of at least one band is 1 while the quantity of the CC within the other band is more than or equal to 2, or, using the single-band ACK/NACK feedback method to feed back the ACK/NACK information of the band, when the CC allocated for the UE is located in the same band, wherein the single-band ACK/NACK feedback method comprises dividing all of the possible ACK/NACK information to be fed back into the four distinct state sets:

state set 0: {DTX};

state set 1: {ACK₁} or {ACK₄};

state set 2: {ACK₂} or {ACK₅};

state set 3: {ACK₃};

wherein a state symbol “ACKᵢ”, i=1, 2, 3, 4 or 5, represents that the UE successfully receives the first data packet sent on the band by the eNB and successfully receives the first i data packets from the first data packet sent on distinct CCs in the band by the eNB.

The process of dividing all of the possible ACK/NACK information of the UE to be fed back into four distinct state sets according to the configuration information of the CC includes:

dividing all of the possible ACK/NACK information of the UE to be fed back into the four distinct state sets {state₁, state₂} in a way as follows, when the CC allocated for the UE is located at two distinct bands and a quantity of the CC of at least one band is 1, wherein state₁ represents the ACK/NACK information of the band containing only one CC among the two bands to be fed back and state₂ represents the ACK/NACK information of the other band to be fed back:

state set 0: {NAK, *} or {*, DTX};

state set 1: {ACK, ACK₁} or {ACK, ACK₄};

state set 2: {ACK, ACK₂};

state set 3: {ACK, ACK₃};

wherein a state symbol “ACKᵢ”, i=1, 2, 3, 4 or 5, represents that the UE successfully receives the first data packet sent on the band by the eNB and successfully receives the first i data packets from the first data packet sent on distinct CCs in the band by the eNB.

The process of dividing all of the possible ACK/NACK information of the UE to be fed back into four distinct state sets according to the configuration information of the CC includes:

dividing all of the possible ACK/NACK information of the UE to be fed back into the four distinct state sets {state₁, state₂} in a way as follows, when the CC allocated for the UE is located at two distinct bands, wherein state₁ represents the ACK/NACK information of any one of the two bands to be fed back and state., represents the ACK/NACK information of the other band to be fed back:

state set 0: {NAK, NAK};

state set 1: {NAK, ACK};

state set 2: {ACK, NAK};

state set 3: {ACK, ACK};

wherein a state symbol “NAK” represents that the state symbols “NACK” and “DTX” in the other band are not differentiated and are collectively mapped as “NAK”.

The process of dividing all of the possible ACK/NACK information of the UE to be fed back into four distinct state sets according to the configuration information of the CC includes:

when the CC allocated for the UE is located at two distinct bands, wherein a quantity of the CC configured in one of the bands is a value of k and the quantity of the CC configured in the other band is m, where k, m, and i are all integers and M∈{1, 2, 3}, wherein when i≦k≦m, ACKᵢ represents that the UE correctly receives the first i successive data packets from the first data packet sent by the eNB in all of the band, and wherein when k≦i≦m, ACKᵢ represents that the UE successfully receives the first k successive data packets from the first data packet in the band containing k CCs, and also successfully receives the first i successive data packets from the first data packet in the band containing m CCs,

dividing all of the possible ACK/NACK information of the UE to be fed back into the four distinct state sets in a way as follows:

state set 0: [DTX};

state set 1: {ACK₁};

state set 2: {ACK₂};

state set 3: {ACK₃}.

The state symbol “DTX” in the state set represents that the UE detects occurrence of at least one of three situations as follows:

situation 1: no sending of the downlink data packet is detected within the band;

situation 2: a loss of at least one downlink data packet is detected within the band; and

situation 3: reception of the first data packet is failed within the band.

In the three situations corresponding to the state symbol “DTX”, the process that the

UE detects the loss of at least one downlink data packet within the band or the UE detects reception failure of the first data packet includes:

sequentially defining a Downlink Allocation Index DAI of the band from a serial number of 1 for the downlink data packet of the band when the eNB successively sends the downlink data packet in the band, wherein its DAI is defined as 1 when the first downlink data packet of the band is sent, and is defined as 2 for the second data packet, and so on.

A state “NAK” in the state set represents that the UE detects occurrence of at least one of three situations as follows:

situation 1: no downlink data packet is detected for all of the CC within the band;

situation 2: there is a loss of the downlink data packet of at least one CC within the band; and

situation 3: reception of at least one data packet is failed within the band.

A state “ACK” represents that the data packet of all of the CC within the band is received successfully.

The process of establishing a one-to-one correspondence relationship between the four state sets and four combinations related to the two-bit indicator information includes:

establishing the one-to-one correspondence relationship between the totally four state sets of state set 0 to state set 3 and the four combinations (0, 0), (0, 1), (1, 0) and (1, 1) related to the two-bit indicator information.

It can be seen from the above technical solutions that in the method for transmitting uplink control information provided by the embodiment of the present invention, by determining the configuration information of the CC allocated to the UE and then coding and mapping the ACK/NACK information of each CC to be fed back as the two-bit indicator information and sending the same, it can be ensured to feed back the ACK/NACK information as much as possible through the SR channel while reducing the CM of the uplink sending signal as much as possible, so as to finally improving frequency spectrum efficiency and uplink throughput of the whole LTE-A system.

### BRIEF DESCRIPTION OF DRAWINGS

FIG. 1 is a diagram illustrating a structure of an SR channel of an LTE system in the prior art;

FIG. 2 is a diagram illustrating the structure of an ACK/NACK channel of the LTE system in the prior art;

FIG. 3 is a schematic diagram illustrating the structure of a radio frame of an LTE-A system in the prior art;

FIG. 4 is a diagram illustrating a configuration of a CC in two frequency bands in the prior art;

FIG. 5 is a schematic diagram illustrating a procedure of a method for transmitting uplink control information in an embodiment of the present invention;

FIG. 6 is a block diagram illustrating that each CC of an LTE-A Frequency Division Duplex (FDD) system generates ACK/NACK information to be fed back in the present invention;

FIG. 7 is a flow chart illustrating that the LTE-A FDD system applies a space bundling method in the present invention;

FIG. 8 is a 1^{st} block diagram illustrating that each CC of the LTE-A FDD system generates the ACK/NACK information to be fed back in the present invention; .

FIG. 9 is a 2^{nd} block diagram illustrating that each CC of the LTE-A FDD system generates the ACK/NACK information to be fed back in the present invention;

FIG. 10 is a schematic diagram illustrating a principle of a third method for dividing four state sets in the present invention;

FIG. 11 is a schematic diagram illustrating the principle of a fourth method for dividing the four state sets in the present invention;

FIG. 12 is a diagram illustrating a mapping relationship between the four state sets and a constellation for indicating four information states in the present invention;

FIG. 13 is a schematic diagram illustrating a reception state when UE receives a downlink data packet in a first embodiment of the present invention; and

FIG. 14 is a schematic diagram illustrating the reception state when the UE receives the downlink data packet in a second embodiment of the present invention.

FIG. 15 illustrates a block diagram of a UE in a mobile communication system according to an embodiment of the present invention.

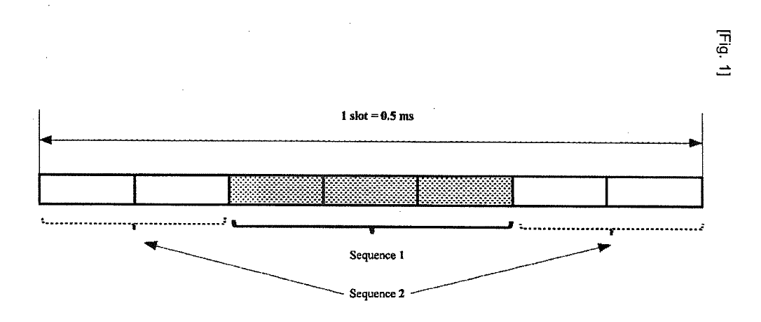

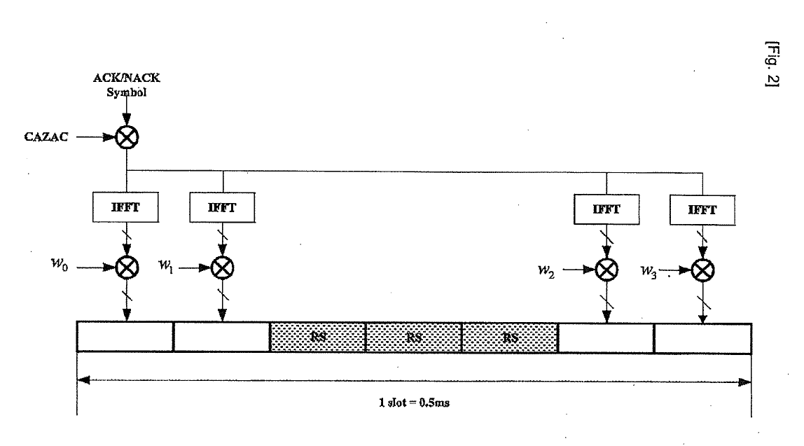

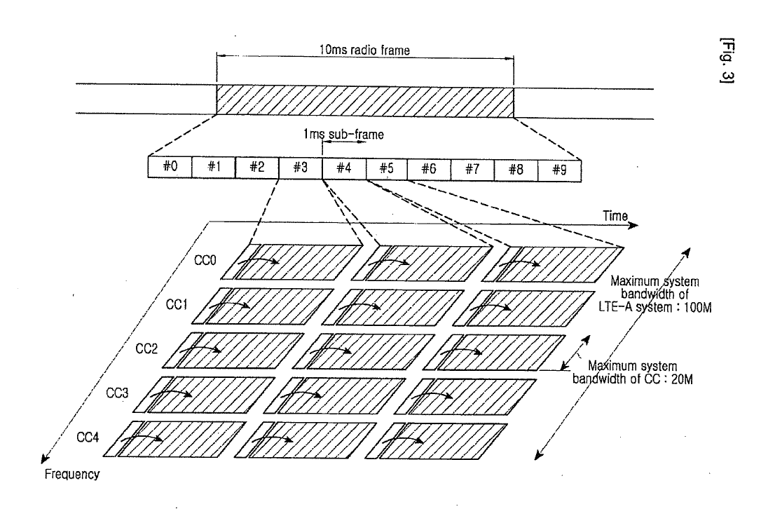

### BEST MODE FOR CARRYING OUT THE INVENTION

To make the objects, technical solutions and advantages of the present invention more apparent, the present invention is described in further detail hereinbelow with reference to the embodiments and the accompanying drawings.

An embodiment of the present invention provides a method for transmitting uplink control information. A procedure of the method is as shown in FIG. 5, which specifically includes the following.

FIG. 5 is a schematic diagram illustrating a procedure of a method for transmitting uplink control information in an embodiment of the present invention.

Referring to FIG. 5, in the step 501, the UE determines configuration information of its CC.

Step 502: The UE receives a downlink data packet of each CC, and generates ACK/NACK information of the CC to be fed back for each CC independently.

Step 503: Indicator information for indicating the ACK/NACK information of the UE that needs to be fed back to an eNB and a channel resource for sending the indicator information are determined according to the configuration information of its CC and whether it is required to send SR information, and the indicator information is sent using the determined channel resource.

Hereinbelow, Steps 501˜503 will respectively be described in detail in combination with a specific example.

Specifically, Step 501 is considered.

A method for the UE to determine the configuration information of its CC includes the following.

The UE receives system information that is broadcasted in its cell or receives Radio Resource Control (RRC) signaling that is sent from the eNB to determine the configuration information of its CC. The configuration information includes at least band information that each CC is located and a serial number that each CC is in the band. By this method, the UE can know accurately in which band the CC configured for itself is located, and a position and the serial number of the CC configured for itself in each band.

Next, Step 502 is considered.

Since an LTE-A system includes an LTE-A FDD system and an LTE-A Time Division Duplex (TDD) system, to generate the ACK/NACK information of the CC to be fed back for each CC independently according to a reception condition of the downlink data packet of each CC includes two situations.

1. For the LTE-A FDD system, one downlink data packet is sent on each CC within a single sub-frame and one or two code words.

FIG. 6 is a block diagram illustrating that each CC of an LTE-A Frequency Division Duplex (FDD) system generates ACK/NACK information to be fed back in the present invention.

Referring to FIG. 6, it is illustrated that totally 5 CCs (CC0˜CC4) are contained in the single sub-frame. Specifically, CC0 and CC1 are allocated as a first band (i.e. a band 1 in FIG. 6), and CC2, CC3 and CC4 are allocated as a second band (i.e. a band 2 in FIG. 6). In addition, 2 code words are contained in the downlink data packet sent on CC0 and CC4 respectively, while 1 code word is contained in the downlink data packet sent on CC1, CC2 and CC3. In order to facilitate description and distinguishing, the first code word (i.e. CW0 in FIG. 6) in each downlink data packet is called a first code word, while the second code word (i.e. CW1 in FIG. 6) in each downlink data packet is called a second code word hereinbelow.

Then in this case, the ACK/NACK information corresponding to each CC is determined by the reception condition of the code word in the CC. Therefore, a method for Step 502 is specifically as follows.

The UE determines whether the downlink data packet is detected on the CC. If not, the ACK/NACK information generated for the CC is “DTX”.

If yes, it is further determined whether the code word contained in the downlink data packet in the CC is all received successfully. If the reception of any of the code word is failed, the ACK/NACK information generated for the CC is “NACK”.

If all of the code word is received successfully, the ACK/NACK information generated for the CC is “ACK”.

2. For the LTE-A TDD system, it is possible that the downlink data packet sent on each CC within a single sub-frame also contains one or two code words. In addition, with respect to any CC in the TDD system, multiple downlink sub-frames are contained within each bundling window. In this case, the ACK/NACK information corresponding to each CC is determined by the reception condition of the code word in the downlink data packet of the multiple sub-frames contained in the CC.

FIG. 7 is a flow chart illustrating that the LTE-A FDD system applies a space bundling method in the present invention.

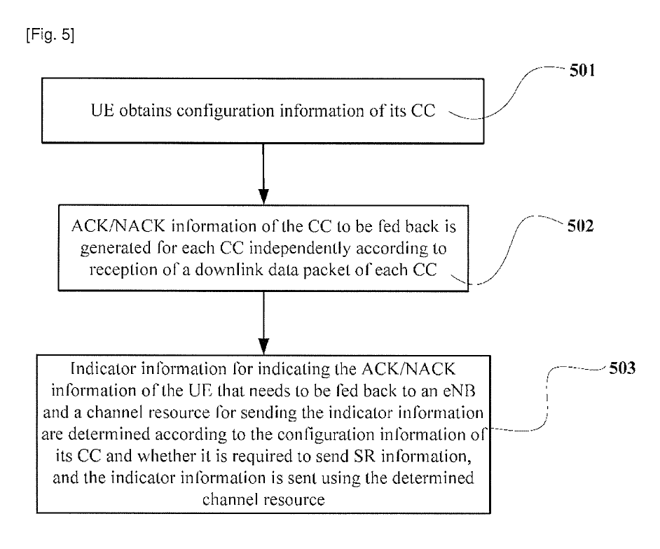

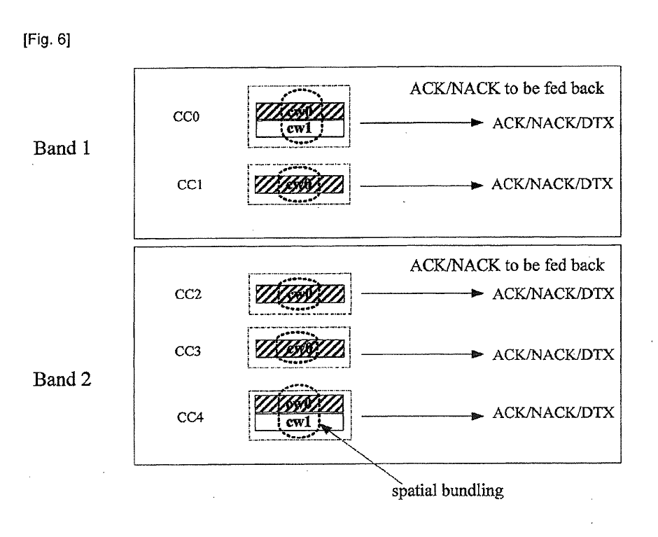

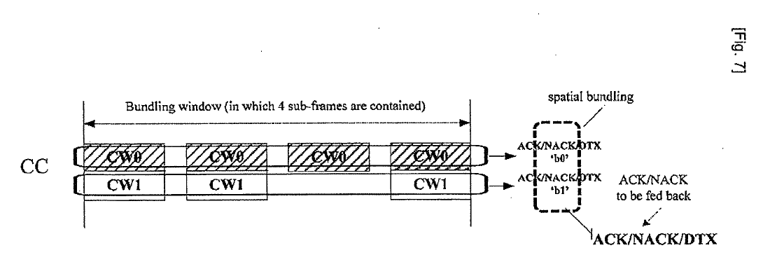

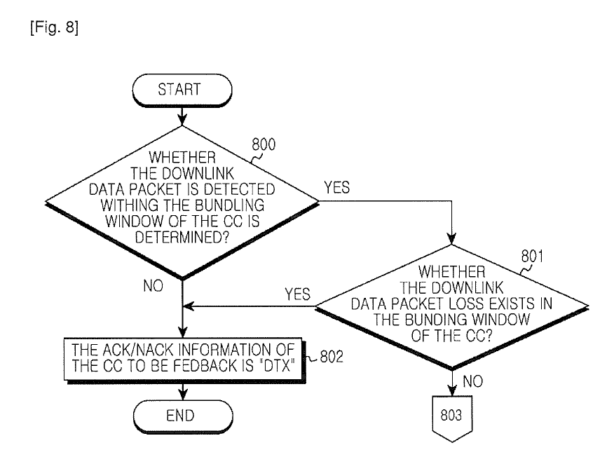

Referring to FIG. 7, it is illustrated that a certain CC contains 4 sub-frames, where 1 code word is contained in the downlink data packet sent on the CC by the third sub-frame, while 2 code words are respectively contained in the downlink data packet sent on the CC by the other three sub-frames. In this case, when the ACK/NACK information corresponding to the CC is determined, firstly a logic And operation is performed for the ACK/NACK information corresponding to each first code word in the multiple sub-frames contained within the bundling window of the CC, and the logic And operation is performed for the ACK/NACK information corresponding to each second code word in the multiple sub-frames contained in the bundling window of the CC, so as to determine the ACK/NACK information of a single code word. Then the ACK/NACK information of the CC to be fed back is generated by performing spatial bundling processing for the ACK/NACK information of all of the code word. The CC shown in FIG. 7 is also taken as an example, the above method means that the logic And operation is performed for the ACK/NACK information (i.e. the ACK/NACK information indicated by b0 in FIG. 7) corresponding to each first code word in the 4 sub-frames contained within the illustrated bundling window, and the logic And operation is performed for the ACK/NACK information (i.e. the ACK/NACK information indicated by b1 in FIG. 7) corresponding to each second code word in the 4 sub-frames, so as to determine the ACK/NACK information of a single code word. That is, firstly the ACK/NACK information of the first code word in the CC is determined, and the ACK/NACK information of the second code word in the CC. Thereafter, the ACK/NACK information of the CC is generated by performing the spatial bundling processing for the ACK/NACK information of the first code word and the second code word. In this case, a method for Step 502 is as shown in FIG. 8, which specifically includes the following.

FIG. 8 is a 1^{st} block diagram illustrating that each CC of the LTE-A FDD system generates the ACK/NACK information to be fed back in the present invention and FIG. 9 is a 2^{nd} block diagram illustrating that each CC of the LTE-A FDD system generates the ACK/NACK information to be fed back in the present invention.

Referring to FIG. 8 and FIG. 9, in the step 800, the UE determines whether the downlink data packet is detected within the bundling window of the CC, and if yes, Step 801 is executed, or otherwise, Step 802 is executed.

Step 801: It is determined whether a downlink data packet loss exists in the bundling window of the CC, and if yes, Step 802 is executed, or otherwise, Step 803 is executed.

Step 802: The ACK/NACK information of the CC to be fed back is generated as “DTX”, and the procedure is terminated.

Step 803: It is determined whether the first code word of all of the sub-frame within the bundling window of the CC is all received successfully, and if yes, Step 805 is executed, or otherwise, Step 804 is executed.

Step 804: The ACK/NACK information of the first code word is set as “NACK”, and Step 806 is executed subsequently.

Step 805: The ACK/NACK information of the first code word is set as “ACK”, and Step 806 is executed subsequently.

Step 806: It is determined whether the second code word of all of the sub-frame within the bundling window of the CC is all received successfully, and if yes, Step 808 is executed, or otherwise, Step 807 is executed.

Step 807: The ACK/NACK information of the second code word is set as “NACK”, and Step 809 is executed subsequently.

Step 808: The ACK/NACK information of the second code word is set as “ACK”, and Step 809 is executed subsequently.

Step 809: it is determined whether the ACK/NACK information of both the first code word and the second code word is “ACK”, and if yes, Step 810 is executed, or otherwise, Step 811 is executed.

Step 810: The ACK/NACK information of the CC to be fed back is determined as “ACK”, and the procedure is terminated.

Step 811: The ACK/NACK information of the CC to be fed back is determined as “NACK”, and the procedure is terminated.

Finally, Step 503 is considered.

The indicator information for indicating the ACK/NACK information of the UE that needs to be fed back to the eNB and the channel resource for sending the indicator information are determined according to the configuration information of its CC and whether it is required to send the SR information, and a method for sending the indicator information using the determined channel resource includes the following.

If within the current sub-frame, the UE needs to send a positive SR while feeding back the ACK/NACK information of each CC, the UE maps the ACK/NACK information of each CC to be fed back as two-bit indicator information according to the configuration information of the CC and a predetermined mapping rule, and modulates the two-bit indicator information onto the SR channel for sending.

Otherwise, the UE maps the ACK/NACK information to be fed back onto the ACK/NACK channel resource for sending.

Specifically, a specific method and process for mapping the ACK/NACK information to be fed back onto the ACK/NACK channel resource for sending is not involved in the discussion of the present invention, and thus the description thereof is omitted.

A method for mapping the ACK/NACK information of each CC to be fed back according to the configuration information of the CC and the predetermined mapping rule as the two-bit indicator information includes the following.

All of the possible ACK/NACK information of the UE to be fed back is divided into four distinct state sets according to the configuration information of the CC, and a one-to-one correspondence relationship is established between the four state sets and four combinations related to the two-bit indicator information.

The ACK/NACK information of the UE of this sub-frame and the state set in which it is located are determined according to the ACK/NACK information of each CC of this sub-frame having been generated, and the two-bit indicator information for indicating the ACK/NACK information of the UE is determined from the correspondence relationship.

It should be noted that due to various possibilities in the configuration for allocating the CC for the UE as well as various situations in downlink data transmission by each CC with respect to each possible configuration, there are various possibilities in all of the possible ACK/NACK information of the UE. However, the two-bit indicator information can only characterize totally four possibilities. Therefore, there are various distinct division methods for the division method for dividing the ACK/NACK information to be fed back into four distinct state sets. In addition, it is easy to understand that a current specific ACK/NACK state of each CC used by the UE cannot entirely be indicated accurately using the indicator information regardless of the division method being used. Therefore, various state set division methods described below are all illustration and explanation of the state set division method merely, and should not be regarded as a limit to the embodiment of the present invention. In addition, other division methods made by those skilled in the art according to the illustrated principle are all included in the scope of the present invention.

Before describing the state set division method by way of an example, firstly a meaning of a state symbol in each state set is described as follows. The meaning of the corresponding state symbol in each division method described below always conforms to that meaning in the absence of a special denotation.

A. The state symbol “DTX” represents that the UE detects occurrence of at least one of the following three situations.

1) No downlink data packet is detected in the band.

2) A loss of at least one downlink data packet is detected in the band.

3) The reception of the first data packet is failed in the band.

B. The state symbol “NAK” represents that the UE detects occurrence of at least one of the following three situations.

1) No downlink data packet is detected in all of the CC of the band.

2) The downlink data packet of at least one CC is lost in the band.

3) The reception of at least one data packet is failed in the band.

C. The state symbol “ACK” represents that the downlink data packet of all of the CC is received successfully in the band.

D. The state symbol “NACK” represents that the reception of the downlink data packet of at least one CC is failed in the band.

E. The state symbol “ACKᵢ”, where i=1, 2, 3, 4 or 5, represents that the UE successfully receives the first data packet sent on the band by the eNB and also successfully receives successive first i data packets from the first data packet that are sent on distinct CCs in the band by the eNB.

According to the description of the above state symbol, it is found the following.

1. The first possible division method: when the CC allocated for the UE is located in two distinct bands and the quantity of the CC in one of the bands is 1 (in order to facilitate description, the band containing 1 CC is denoted as band 1 while the other band is denoted as band 2 hereinbelow, the ACK/NACK information of band 1 to be fed back is represented by state 1, and the ACK/NACK information of band 2 to be fed back is represented by state 2), a specific method for dividing all of the possible ACK/NACK information of the UE to be fed back into 4 state sets is as shown in Table 1 below.

TABLE 1

| | {state1, state2} | | |
|---|---|---|---|
| Serial number | Scheme 0 | Scheme 1 | Scheme 2 |
| State set 0 | {DTX, *} | {DTX, *} | {DTX, DTX} |
| State set 1 | {NACK, *} | {ACK, *} | {ACK, *} |
| State set 2 | {ACK, DTX} | {NACK, DTX} | {NACK, *} |
| State set 3 | {ACK, **} | {NACK, **} | {DTX, **} |

In Table 1, the state symbol “*” represents that the ACK/NACK information of the band to be fed back can be arbitrary, while the state symbol “**” represents that at least the first downlink data packet is received successfully on the band. It is easy to understand that the meaning represented by the state symbol “**” and the state symbol “DTX” exactly complement each other.

In Table 1, the division rule for the state set is to feed back the ACK/NACK information of band 1 accurately, and to ensure that the reception states “DTX”, “ACK” and “NACK” of the downlink data packet within a single CC in band 1 are fed back in distinct state sets. It is easy to understand that the reception state of the downlink data packet of a single CC in band 1 includes only 3 situations (i.e. DTX, ACK or NACK), while the quantity of the state set is 4. Therefore, Schemes 0˜2 differ from each other in that one of the 3 reception states is further distinguished in each scheme respectively.

For example, the situation that band 1 is in the “ACK” state is further distinguished in Scheme 0. The situation that band 1 is in the “ACK” state is divided into {ACK, DTX} and {ACK, **}. That is, the state set 2 in Scheme 0 represents that band 1 is in the “ACK” state and band 2 is in the “DTX” state. Accordingly, the state set 3 represents that at this time, band 1 is in the “ACK” state and band 2 is in the “**” state.

Similarly, the situation that band 1 is in the “NACK” state is further distinguished in Scheme 1. The situation that band 1 is in the “NACK” state is divided into {NACK, DTX} and {NACK, **}. That is, the state set 2 in Scheme 1 represents that band 1 is in the “NACK” state and band 2 is in the “DTX” state. Accordingly, the state set 3 represents that at this time, band 1 is in the “NACK” state and band 2 is in the “**” state. Likewise, it can be found that the situation that band 1 is in the “DTX” state is further distinguished in Scheme 2.

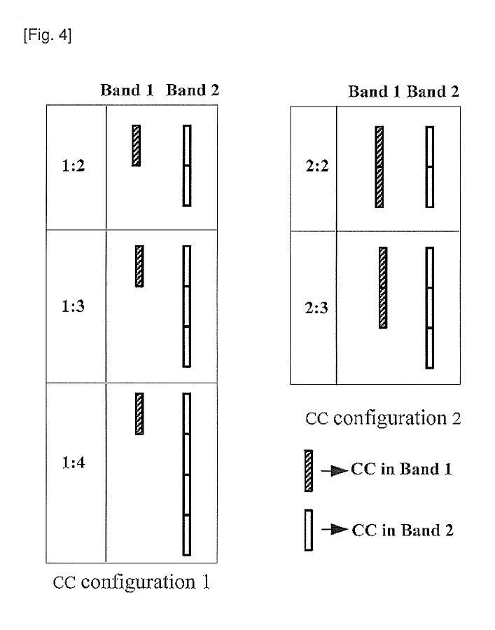

It can be seen that, the state set division method as shown in Table 1 is to accurately feed back the ACK/NACK information of the band containing 1 CC to be fed back, and meanwhile to feed back the reception state of the downlink data packet in the other band at the best effort. It is easy to understand that the feedback for the reception state of the downlink data packet in another band apparently lacks accuracy in such division method, and the accuracy thereof decreases as the quantity of the CC contained in the other band is increased. Therefore, the method is suitable for the situation that the quantity of the CC contained in the other band is relatively small, e.g. the situation that 1 CC is contained in band 1 while 2 CCs are contained in band 2 as shown in FIG. 4.

2. The second possible division method: when the CC allocated for the UE is located in two distinct bands and the quantity of the CC in one of the bands is 1 while the quantity of the CC in another band is more than or equal to 2, or when all of the CC allocated for the UE is located in the same band, a specific method for dividing all of the possible ACK/NACK information of the UE to be fed back into 4 state sets is as shown in Table 2 below.

TABLE 2

| Serial | The quantity of a successive ACK from the first |
|---|---|
| number | data packet within a single band is fed back |
| State set 0 | {DTX} |
| State set 1 | {ACK₁} or {ACK₄} |
| State set 2 | {ACK₂} or {ACK₅} |
| State set 3 | {ACK₃} |

In Table 2, the division rule for the state set is not to feed back the ACK/NACK information of the band containing 1 CC and to feed back only the ACK/NACK information of the band containing two or more CCs when the CC allocated for the UE is located in two distinct bands and the quantity of the CC in one of the bands is 1 while the quantity of the CC in another band is more than or equal to 2, and to feed back the ACK/NACK information of the band when all of the CC allocated for the UE is located in the same band. State set 1 is taken as an example. It is assumed that in this case, 5 CCs are allocated for the UE and the 5 CCs are located in the same band, then ACK, represents that 1 data packet is successfully received successively from the first data packet within the band in this case, while ACK₄ represents that 4 data packets are successfully received successively from the first data packet within the band in this case. Similarly, for the state set 2, the same assumption is considered, then ACK₂ represents that 2 data packets are successfully received successively from the first data packet within the band in this case, while ACK₅ represents that 5 data packets are successfully received successively from the first data packet within the band in this case (i.e. the downlink data packet in all of the CC is received successfully).

It is easy to understand that the division method as shown in Table 2 is more suitable for the feedback of the reception state of the downlink data packet in the band containing multiple CCs, e.g. the situation as shown in FIG. 4 that 1 CC is contained in band 1 while 2˜4 CCs are contained in band 2, or the situation that all of the CC is located in the same band and the quantity of the CC in the band is more than or equal to 2.

3. The third possible division method: when the CC allocated for the UE is located in two distinct bands and the quantity of the CC in at least one of the bands is 1 (in order to facilitate description, the band containing 1 CC is denoted as band 1 while the other band is denoted as band 2 hereinbelow (it should be noted that the quantity of the CC contained in band 2 may also be 1 in this case), and the meaning of state 1 and state 2 is the same as in the above and the description thereof is omitted), a specific method for dividing all of the possible ACK/NACK information of the UE to be fed back into 4 state sets is as shown in Table 3 below.

TABLE 3

| Serial number | {state₁, state₂} |
|---|---|
| State set 0 | {NAK, *} [symbol] {*, DTX} |
| State set 1 | {ACK, ACK₁} [symbol] {ACK, ACK₄} |
| State set 2 | {ACK, ACK₂} |
| State set 3 | {ACK, ACK₃} |

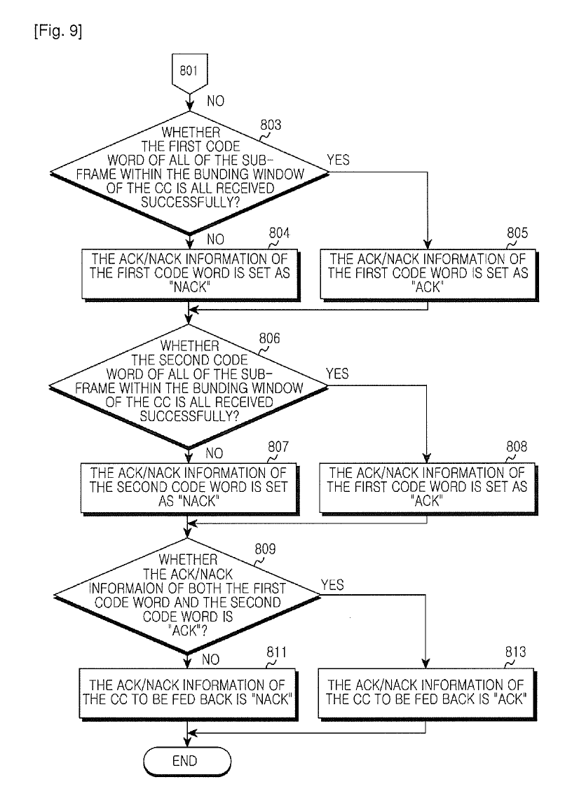

In Table 3, the division rule for the state set is that band 1 and band 2 employs different ACK/NACK information feedback methods from each other. Specifically, the state symbol used by band 1 can describe the reception state of the downlink data packet accurately, while the state symbol used by band 2 feeds back the quantity of the data packet successfully received successively from the first data packet within the band when no data packet loss is detected in the band. FIG. 10 depicts an implementation manner of the rule.

FIG. 10 is a schematic diagram illustrating a principle of a third method for dividing four state sets in the present invention.

Referring to FIG. 10, it is easy to understand that the division method as shown in Table 3 is more suitable for the situation that band 2 contains multiple CCs, e.g. the situation as shown in FIG. 4 that 1 CC is contained in band 1 while 2˜4 CCs are contained in band 2.

4. The fourth possible division method: when the CC allocated for the UE is located in two distinct bands (in order to facilitate description, one of the bands is denoted as band 1 while the other band is denoted as band 2 hereinbelow, and the meaning of state 1 and state 2 is the same as in the above and the description thereof is omitted), a specific method for dividing all of the possible ACK/NACK information of the UE to be fed back into 4 state sets is as shown in Table 4 below.

TABLE 4

| Serial number | {state₁, state₂} |
|---|---|
| State set 0 | {NAK, NAK} |
| State set 1 | {NAK, ACK} |
| State set 2 | {ACK, NAK} |
| State set 3 | {ACK, ACK} |

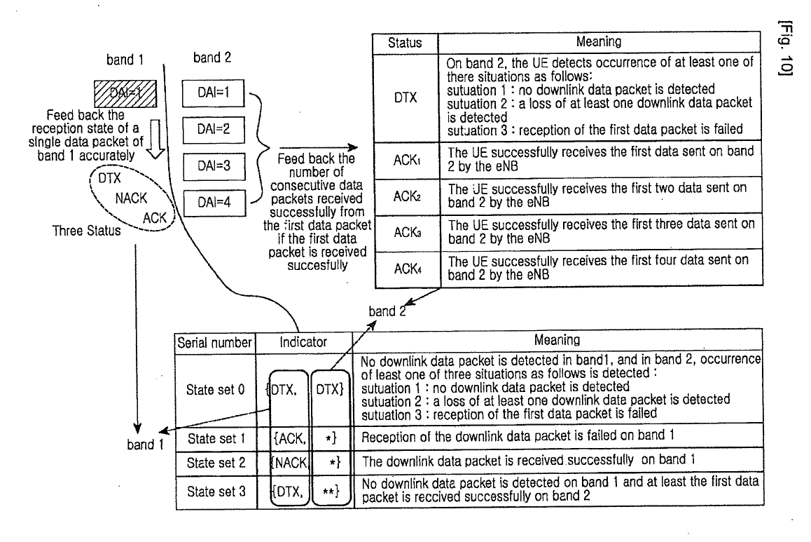

In Table 4, the division rule for the state set is that after the ACK/NACK information of each CC to be fed back is determined in Step 502, the ACK/NACK information of each band to be fed back is determined according to the reception condition of the downlink data packet in this sub-frame for the band in two state symbols (“ACK” and “NACK”) using a band bundling method. That is, after the ACK/NACK information of each CC to be fed back in each band is determined in Step 502, the ACK/NACK information of each band to be fed back is further determined (in addition, the ACK/NACK information is represented by the ACK or NAK state symbol). FIG. 11 depicts a manner that the rule is used practically.

FIG. 11 is a schematic diagram illustrating the principle of a fourth method for dividing the four state sets in the present invention.

Referring to FIG. 11, it is easy to understand that the division method as shown in Table 4 is more suitable for the situation that the quantity of the CC contained in band 1 is close to that in band 2, e.g. the situation as shown in FIG. 4 that 1 CC is contained in band 1 and 2 CCs are contained in band 2, or the situation that 2 CCs are contained in both band 1 and band 2.

5. The fifth possible division method: when the CC allocated to the UE is located in two distinct bands (in order to facilitate description, one of the bands is denoted as band 1 while the other band is denoted as band 2 hereinbelow), a specific method for dividing all of the possible ACK/NACK information of the UE to be fed back into 4 state sets is as shown in Table 5 below.

TABLE 5

| Serial number | Indicator |
|---|---|
| State set 0 | {DTX} |
| State set 1 | {ACK₁} |
| State set 2 | {ACK₂} |
| State set 3 | {ACK₃} |

In Table 5, it should be noted that the meaning of ACKᵢ differs from that having been described above in E. It is assumed that the quantity of the CC configured in band 1 is k while the quantity of the CC configured in band 2 is m, where k, m, and i are all integers and m∈{1, 2, 3}. When i≦k≦m, ACKᵢ represents that the UE correctly receives the first i successive data packets from the first data packet sent by the eNB in all of the band. When k≦i≦m, ACKᵢ represents that the UE successfully receives the first k successive data packets from the first data packet in the band containing k CCs, and also successfully receives the first i successive data packets from the first data packet in the band containing m CCs.

It is easy to understand that the division method as shown in Table 5 is also more suitable for the situation that the quantity of the CC contained in band 1 is close to that in band 2, e.g. the situation as shown in FIG. 4 that 1 CC is contained in band 1 and 2 CCs are contained in band 2, or the situation that 2 CCs are contained in band 1 and 2 or 3 CCs are contained in band 2.

Finally, in the state set division methods describe in the above parts 1 to 5, among the three situations represented by “DTX”, in order to ensure that the UE can detects the 2^{nd} and 3^{rd} situations, it is required to sequentially define a Downlink Allocation Index (DAI) of the band from a serial number of 1 for the downlink data packet of the band. That is, the DAI thereof is defined as 1 when the first downlink data packet of the band is sent, and is defined as 2 for the second data packet, and so on. In this way, the UE can determine the quantity of the data packet lost or failed in reception during downlink data transmission and the position of the data packet.

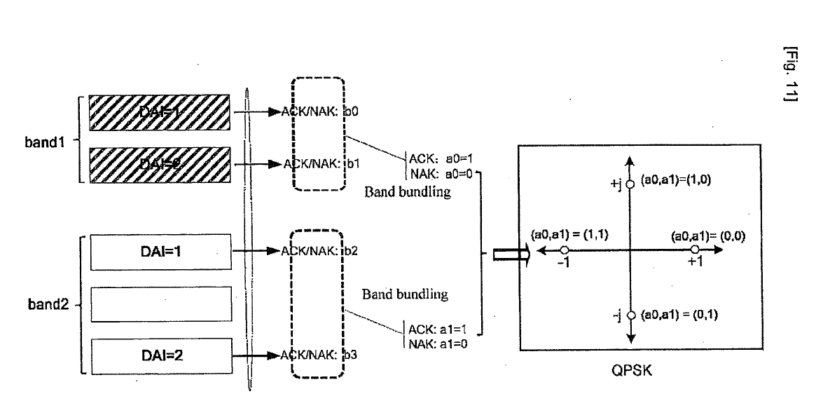

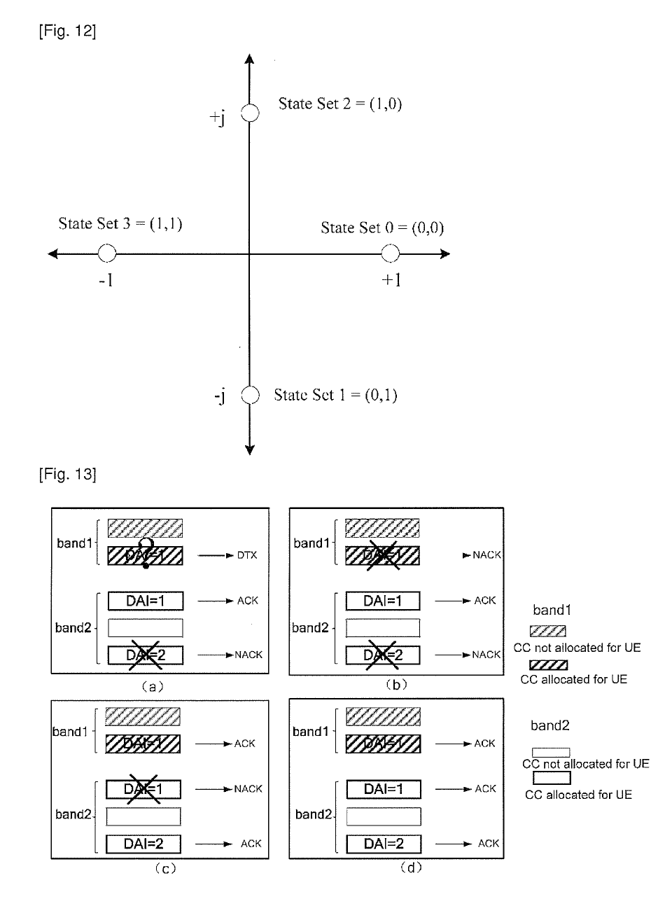

After the ACK/NACK information of the UE of this sub-frame to be fed back and the state set that it is located are determined according to the ACK/NACK information of each CC of this sub-frame having been generated to be fed back, the method for determining the two-bit ACK/NACK information for indicating the UE from the correspondence relationship may employ the mapping by the constellation map as shown in FIG. 12.

FIG. 12 is a diagram illustrating a mapping relationship between the four state sets and a constellation for indicating four information states in the present invention.

Referring to FIG. 12, specifically, (0, 0) represents state set 0, (0, 1) represents state set 1, (1, 0) represents state set 2, and (1, 1) represents state set 3. It is easy to understand that another mapping rule may also be used, as long as the one-to-one correspondence relationship between the four state sets and four combinations related to the two bits can be established.

In order to explain the specific implementation principle of the present invention in further detail, description is made in combination with two specific application examples.

### Embodiment 1

It is assumed that two bands is configured for the UE. As shown in FIG. 13.

FIG. 13 is a schematic diagram illustrating a reception state when UE receives a downlink data packet in a first embodiment of the present invention.

Referring to FIG. 13, the eNB configures a CC for the UE in band 1, while there are 3 CCs in band 2 and the eNB configures 2 CCs thereof for the UE. The following four scenarios are considered.

Scenario 0: It is assumed that in this case, the UE detects no downlink data in band 1, while the downlink data packet sent on the first CC is received successfully on band 2, and the reception of the second downlink data packet is failed in band 2, as shown in FIG. 13(a).

Scenario 1: It is assumed that in this case, the UE has detected the downlink data but the reception is failed, while the downlink data packet sent on the first CC in band 2 is received successfully, and the reception of the second downlink data packets failed in band 2, as shown in FIG. 13(b).

Scenario 2: It is assumed that in this case, the UE receives the downlink data successfully in band 1, and fails to receive the downlink data packet on the first CC within band 2, but receives the downlink data packet in the second CC successfully, as shown in FIG. 13(c).

Scenario 3: It is assumed that in this case, the UE receives all of the downlink data on all of the band, as shown in FIG. 13(d).

For the above four scenarios, the indicator information sent on the SR channel using different feedback methods and after performing the mapping using the constellation map as shown in FIG. 12 is as shown in Tables 6˜10 below.

1) The two-bit indicator information sent on the SR resource determined by using the state set division method as described in Table 1 and performing the mapping in combination with the constellation map as shown in FIG. 12 is as shown in Table 6 below.

TABLE 6

| Scenario | Scheme 0 | Scheme 1 | Scheme 2 |
|---|---|---|---|
| Scenario 0 | (0, 0) | (0, 0) | (1, 1) |
| Scenario 1 | (0, 1) | (1, 1) | (1, 0) |
| Scenario 2 | (1, 0) | (0, 1) | (0, 1) |
| Scenario 3 | (1, 1) | (0, 1) | (0, 1) |

2) The two-bit indicator information sent on the SR resource determined by using the state set division method as described in Table 2 and performing the mapping in combination with the constellation map as shown in FIG. 12 is as shown in Table 7 below.

TABLE 7

| Scenario | Indicator information |
|---|---|
| Scenario 0 | (0, 1) |
| Scenario 1 | (0, 1) |
| Scenario 2 | (0, 0) |
| Scenario 3 | (1, 0) |

3) The two-bit indicator information sent on the SR resource determined by using the state set division method as described in Table 3 and performing the mapping in combination with the constellation map as shown in FIG. 12 is as shown in Table 8 below.

TABLE 8

| | Indicator |
|---|---|
| Scenario | information |
| Scenario 0 | (0, 0) |
| Scenario 1 | (0, 0) |
| Scenario 2 | (0, 0) |
| Scenario 3 | (1, 0) |

The two-bit indicator information sent on the SR resource determined by using the state set division method as described in Table 4 and performing the mapping in combination with the constellation map as shown in FIG. 12 is as shown in Table 9 below.

TABLE 9

| | Indicator |
|---|---|
| Scenario | information |
| Scenario 0 | (0, 0) |
| Scenario 1 | (0, 0) |
| Scenario 2 | (1, 0) |
| Scenario 3 | (1, 1) |

The two-bit indicator information sent on the SR resource determined by using the state set division method as described in Table 5 and performing the mapping in combination with the constellation map as shown in FIG. 12 is as shown in Table 10 below.

TABLE 10

| Scenario | Indicator information |
|---|---|
| Scenario 0 | (0, 0) |
| Scenario 1 | (0, 0) |
| Scenario 2 | (0, 0) |
| Scenario 3 | (1, 0) |

### Embodiment 2

It is assumed that in this embodiment, the eNB configures two bands for the UE, as shown in FIG. 13, where the eNB configures 2 CCs for the UE in band 1, and there are 3 CCs in band 2 and the eNB configures all of the CC for the UE. The following four scenarios are considered.

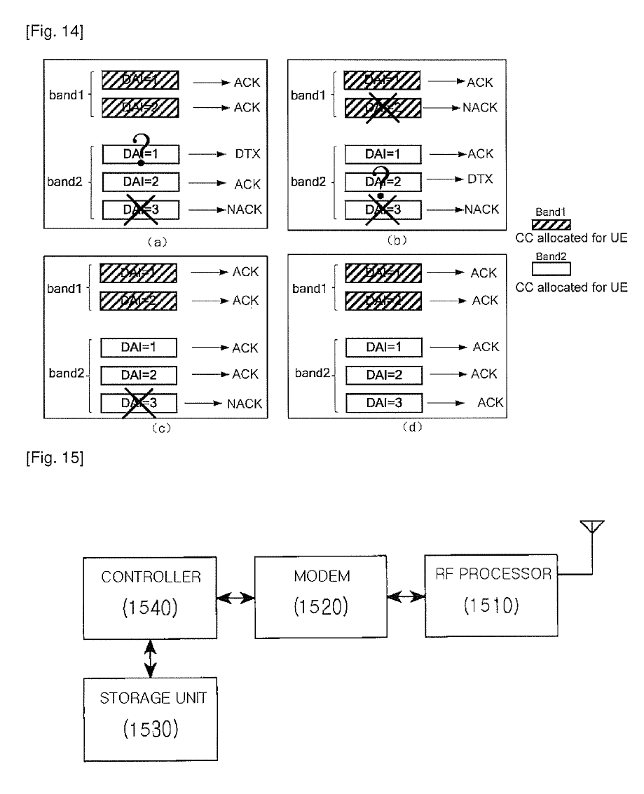

FIG. 14 is a schematic diagram illustrating the reception state when the UE receives the downlink data packet in a second embodiment of the present invention.

Referring to FIG. 14, in scenario 0: It is assumed that the UE receives the downlink data packet successfully in both CCs of band 1, and detects the downlink data packet within the first CC of band 2, receives the downlink data packet successfully within the second CC, and failed in reception within the third CC, as shown in FIG. 14(a).

Scenario 1: It is assumed that the UE receives the downlink data packet successfully in the first CC of band 1 and fails to receive the downlink data packet in the second CC, and receives the downlink data packet successfully within the first CC of band 2, detects no downlink data within the second CC, and fails to receive data within the third CC, as shown in FIG. 14(b).

Scenario 2: It is assumed that the UE receives the downlink data successfully within both CCs of band 1, and receives the downlink data successfully on the first and the second CCs within band 2, but fails to receive the downlink data packet in the third CC, as shown in FIG. 14(c).

Scenario 3: It is assumed that the UE receives all of the downlink data on all of the band, as shown in FIG. 14(d).

For the above four scenarios, the indicator information sent on the SR channel using different feedback methods and after performing the mapping using the constellation map as shown in FIG. 12 is as shown in Tables 6˜10 below.

1) The two-bit indicator information sent on the SR resource determined by using the state set division method as described in Table 3 and performing the mapping in combination with the constellation map as shown in FIG. 12 is as shown in Table 11 below.

TABLE 11

| | Indicator |
|---|---|
| Scenario | information |
| Scenario 0 | (0, 0) |
| Scenario 1 | (0, 0) |
| Scenario 2 | (1, 0) |
| Scenario 3 | (1, 1) |

2) The two-bit indicator information sent on the SR resource determined by using the state set division method as described in Table 4 and performing the mapping in combination with the constellation map as shown in FIG. 12 is as shown in Table 12 below.

TABLE 12

| Scenario | Indicator information |
|---|---|
| Scenario 0 | (1, 0) |
| Scenario 1 | (0, 0) |
| Scenario 2 | (1, 0) |
| Scenario 3 | (1, 1) |

3) The two-bit indicator information sent on the SR resource determined by using the state set division method as described in Table 5 and performing the mapping in combination with the constellation map as shown in FIG. 12 is as shown in Table 13 below.

TABLE 13

| Scenario | Indicator information |
|---|---|
| Scenario 0 | (0, 0) |
| Scenario 1 | (0, 1) |
| Scenario 2 | (1, 0) |
| Scenario 3 | (1, 1) |

FIG. 15 illustrates a block diagram of a UE in a mobile communication system according to an embodiment of the present invention.

Referring to FIG. 15, the UE includes a Radio Frequency (RF) processor 1510, a modem 1520, a storage unit 1530 and a controller 1540.

The RF processor 1510 performs functions, such as signal band converting and amplification, to transmit and receive signals over a radio channel. That is, the RF processor 1510 up-converts a baseband signal output from the modern 1520 to the RF signal and transmits the RF signal over an antenna, and down-converts the RF signal received over the antenna to the baseband signal. For example, the RF processor 1510 may include an amplifier, a mixer, an oscillator, a Digital to Analog Convertor (DAC), a Analog to Digital Convertor (ADC) and so on.

The modem 1520 converts the baseband signal and a bit string according to a physical layer standard of the system. For example, to transmit data, the modem 1520 generates complex symbols by encoding and modulating the transmit bit string, maps the complex symbols to subcarriers, and constitutes OFDM symbols by applying Inverse Fast Fourier Transform (IFFT) and inserting a Cyclic Prefix (CP). When receiving data, the modem 1520 splits the baseband signal output from the RF processor 1510 to OFDM symbols, restores the signals mapped to the subcarriers using FFT, and restores the receive bit string by demodulating and decoding the signals. The storage unit 1530 stores program codes and system information required for the operations of the UE. The storage unit 1530 provide stored data to the controller 1540 upon a request from the controller 1540. The controller 1540 controls the functions of the UE. For example, the controller 1540 generates a transmit packet and a message and provides the modem 1520 with the transmit packet and the message. And the controller 1540 processes a receive packet and a message from the modem 1520.

More particularly, according to an exemplary embodiment of the present invention, the controller 1540 determines the configuration information of the CC allocated to the UE and then performs coding and mapping the ACK/NACK information of each CC to be fed back as the two-bit indicator information and performs sending the same. That is, the controller 1540 may control to feed back the ACK/NACK information as much as possible through the SR channel while reducing the CM of the uplink sending signal as much as possible. For example, the controller 1540 controls so that the UE operates as illustrated in one of FIG. 5 to FIG. 13.

It can be seen from the above technical solutions that in the method for transmitting uplink control information provided by the embodiment of the present invention, by determining the configuration information of the CC allocated to the UE and then coding and mapping the ACK/NACK information of each CC to be fed back as the two-bit indicator information and sending the same, it can be ensured to feed back the ACK/NACK information as much as possible through the SR channel while reducing the CM of the uplink sending signal as much as possible, so as to finally improving frequency spectrum efficiency and uplink throughput of the whole LTE-A system.

The foregoing is merely preferred embodiments of the present invention, and the scope of the present invention is not limited thereto. Any modifications, equivalents or improvements made without departing from the spirit and principle of the present invention are intended to fall into the scope of the present invention.

1. A method for transmitting uplink control information, the method comprising:
identifying, by a User Equipment (UE), configuration information of a Component Carrier (CC) of the UE;
receiving, by the UE, a downlink data packet of each CC;
generating acknowledgement/negative acknowledgement (ACK/NACK) information of the CC to be fed back for each CC independently;
identifying indicator information for indicating the ACK/NACK information of the UE that is to be fed back to an evolved Node-B (eNB) and a channel resource for sending the indicator information according to the configuration information of the CC;
determining whether sending a Scheduling Requirement (SR) information is required; and
sending an indicator message using the identified channel resource.

2. The method according to claim 1, wherein identifying the configuration information of the CC of the UE comprises:
receiving, by the UE, one of system information broadcasted in a cell of the UE and radio resource control signaling sent from the eNB to determine the configuration information of the CC, wherein the configuration information includes at least information of a band that each CC is located and a serial number of each CC in the band.

3. The method according to claim 1, wherein of receiving the downlink data packet of each CC and generating the ACK/NACK information of the CC to be fed back for each CC independently comprises:
receiving the downlink data packet sent on each CC within a current sub-frame which contains one or two code words; and
identifying, by the UE, the ACK/NACK information of the CC to be fed back according to a reception state of all of the one or two code words.

4. The method according to claim 3, wherein identifying the ACK/NACK information of the CC to be fed back according to a reception state of all of the code word comprises:
setting the ACK/NACK information to be fed back as ACK if the UE receives all of the one or two code words successfully;
setting the ACK/NACK information to be fed back as DTX if no downlink data packet sending is detected; and
setting the ACK/NACK information to be fed back as NACK if reception of any code word of the downlink data packet is failed.

5. The method according to claim 1, wherein identifying indicator information for indicating the ACK/NACK information of the UE that is to be fed back to the eNB and a channel resource for sending the indicator information according to the configuration information of the CC, determining whether sending the SR information is required, and sending the indicator message using the identified channel resource comprises:
coding and mapping, by the UE, the ACK/NACK information of each CC to be fed back as two-bit indicator information according to the configuration information of the CC and in accordance with a predetermined mapping rule and modulating the two-bit indicator information onto an SR channel for sending, if within a current sub-frame, the UE sends a positive SR while feeding back the ACK/NACK information of each CC; and
mapping, by the UE, the ACK/NACK information to be fed back onto an ACK/NACK channel resource for sending, if not within the current sub-frame.

6. The method according to claim 5, wherein coding and mapping, by the UE, the ACK/NACK information of each CC to be fed back as two-bit indicator information according to the configuration information of the CC and in accordance with the predetermined mapping rule comprises:
dividing all possible ACK/NACK information of the UE to be fed back into four state sets according to the configuration information of the CC;
establishing a one-to-one correspondence relationship between the four state sets and four combinations related to the two-bit indicator information; and
identifying the ACK/NACK information of the UE of the current sub-frame to be fed back and the state set that of the ACK/NACK information; and
identifying the two-bit indicator information for indicating the ACK/NACK information of the UE according to the correspondence relationship.

7. The method according to claim 6, wherein dividing all of the possible ACK/NACK information of the UE to be fed back into the four state sets according to the configuration information of the CC comprises:
dividing all of the possible ACK/NACK information of the UE to be fed back into the four distinct state sets {state₁, state₂} as follows, when the CC allocated for the UE is located at two distinct bands and a quantity of the CC of at least one band is 1, wherein state₁ represents the ACK/NACK information of the band containing only one CC among the two bands to be fed back and state₂ represents the ACK/NACK information of another band to be fed back:
state set 0: {DTX, *};
state set 1: {NACK, *};
state set 2: {ACK, DTX};
state set 3: {ACK, **};
wherein a state symbol “NACK” represents that reception of the downlink data packet of at least one CC within the band is failed,
the state symbol “*” represents it is possible that the ACK/NACK information to be fed back is arbitrary, and the state symbol “**” represents that at least the first downlink data packet is received successfully on the band,
wherein dividing all of the possible ACK/NACK information of the UE to be fed back into the four state sets according to the configuration information of the CC further comprises:
using a single-band ACK/NACK feedback method to feed back the ACK/NACK information of the band containing multiple CCs, when the CC allocated for the UE is located at two distinct bands and a quantity of the CC of at least one band is 1 while the quantity of the CC within the other band is more than or equal to 2; and
using the single-band ACK/NACK feedback method to feed back the ACK/NACK information of the band, when the CC allocated for the UE is located in the same band, wherein the single-band ACK/NACK feedback method comprises dividing all of the possible ACK/NACK information to be fed back into the four distinct state sets:
state set 0: DTX};
state set 1: {ACK₁} or {ACK₄};
state set 2: {ACK₂} or {ACK₅};
state set 3: {ACK₃ };
wherein a state symbol “ACKᵢ”, i=1, 2, 3, 4 or 5, represents that the UE successfully receives the first data packet sent on the band by the eNB and successfully receives the first i data packets from the first data packet sent on distinct CCs in the band by the eNB and
wherein dividing all of the possible ACK/NACK information of the UE to be fed back into the four state sets according to the configuration information of the CC further comprises:
when the CC allocated for the UE is located at two distinct bands, dividing all of the possible ACK/NACK information of the UE to be fed back into the four state sets follows:
state set 0: {DTX};
state set 1: {ACK₁};
state set 2: {ACK₂};
state set 3: {ACK₃}
wherein a quantity of the CC configured in one of the bands is a value of k and the quantity of the CC configured in the other band is m, where k, m, and i are all integers and m∈{1, 2, 3}, wherein when i≦k≦m, ACKᵢ represents that the UE correctly receives the first i successive data packets from the first data packet sent by the eNB in all of the band, and wherein when k≦i≦m, ACK, represents that the UE successfully receives the first k successive data packets from the first data packet in the band containing k CCs, and also successfully receives the first i successive data packets from the first data packet in the band containing m CCs.

8. The method according to claim 6, wherein dividing all of the possible ACK/NACK information of the UE to be fed back into the four state sets according to the configuration infoi nation of the CC comprises:
dividing all of the possible ACK/NACK information of the UE to be fed back into the four distinct state sets {state₁, state₂} as follows, when the CC allocated for the UE is located at two distinct bands and a quantity of the CC of at least one band is 1, wherein state, represents the ACK/NACK information of the band containing only one CC among the two bands to be fed back and state₂ represents the ACK/NACK information of the other band to be fed back:
state set 0: {NAK, *} or {*, DTX};
state set 1: {ACK, ACK₁} or {ACK, ACK₄};
state set 2: {ACK, ACK₂};
state set 3: {ACK, ACK₃};
wherein a state symbol “ACKᵢ”, i=1, 2, 3, 4 or 5, represents that the UE successfully receives the first data packet sent on the band by the eNB and successfully receives the first i data packets from the first data packet sent on distinct CCs in the band by the eNB.

9. The method according to claim 6, wherein dividing all of the possible ACK/NACK information of the UE to be fed back into the four state sets according to the configuration information of the CC comprises:
dividing all of the possible ACK/NACK information of the UE to be fed back into the four distinct state sets {state₁, state₂} as follows, when the CC allocated for the UE is located at two distinct bands, wherein state, represents the ACK/NACK information of any one of the two bands to be fed back and state₂ represents the ACK/NACK information of the other band to be fed back:
state set 0: {NAK, NAK};
state set 1: {NAK, ACK};
state set 2: {ACK, NAK};
state set 3: {ACK, ACK};
wherein a state symbol “NAK” represents that the state symbols “NACK” and “DTX” in the other band are not differentiated and are collectively mapped as “NAK”.

10. The method according to claim 7, wherein the state symbol “DTX” in the state set represents that the UE detects occurrence of at least one of three situations as follows:
situation 1: no sending of the downlink data packet is detected within the band;
situation 2: a loss of at least one downlink data packet is detected within the band; and
situation 3: reception of the first data packet is failed within the band.

11. The method according to claim 10 wherein in the three situations corresponding to the state symbol “DTX”, the process that the UE detects the loss of at least one downlink data packet within the band or the UE detects reception failure of the first data packet comprises:
sequentially defining a Downlink Allocation Index DAI of the band from a serial number of 1 for the downlink data packet of the band when the eNB successively sends the downlink data packet in the band, wherein its DAI is defined as 1 when the first downlink data packet of the band is sent, and is defined as 2 for the second data packet, and so on.

12. The method according to claim 8, wherein a state “NAK” in the state set represents that the UE detects occurrence of at least one of three situations as follows:
situation 1: no downlink data packet is detected for all of the CC within the band;
situation 2: there is a loss of the downlink data packet of at least one CC within the band; and
situation 3: reception of at least one data packet is failed within the band.

13. The method according to any one of claim 7, wherein a state “ACK” represents that the data packet of all of the CC within the band is received successfully.

14. The method according to claim 6, wherein the process of establishing a one-to-one correspondence relationship between the four state sets and four combinations related to the two-bit indicator information comprises:
establishing the one-to-one correspondence relationship between the totally four state sets of state set 0 to state set 3 and the four combinations (0, 0), (0, 1), (1, 0) and (1, 1) related to the two-bit indicator information.

15. An apparatus of a User Equipment (UE) configured to transmit uplink control information, the apparatus comprising:
a controller configured to identify confinuration information of a Component Carrier (CC) of the UE; and
an RF processor configured to receive a downlink data packet of each CC,
wherein the controller is further configured to generate acknowledgement/neoative acknowledgement (ACK/NACK) information of the CC to be fed back for each CC independently, identify indicator information for indicating the ACK/NACK information of the UE that is to be fed back to an evolved Node-B (eNB) and a channel resource for sending the indicator information according to the configuration information of the CC, and determine whether sending, a Scheduling Requirement (SR) information is required,
wherein the RF processor is further configured to send an indicator message using the identified channel resource.

16. The apparatus according to claim 15, wherein to identify the configuration information of the CC of the UE the controller is configured to receive one of system information broadcasted in a cell of the UE and radio resource control signaling sent from the eNB to determine the configuration information of the CC, wherein the configuration information includes at least information of a band that each CC is located and a serial number of each CC in the band.

17. The apparatus according to claim 15, wherein to receive the downlink data packet of each CC the RF processor is configured to receive the downlink data packet sent on each CC within a current sub-frame which contains one or two code words, and
wherein to generate the ACK/NACK information of the CC to be fed back for each CC independently the controller is configured to identify the ACK/NACK information of the CC to be fed back according to a reception state of all of the one or two code words.

18. The method according to claim 8, wherein the state symbol “DTX” in the state set represents that the UE detects occurrence of at least one of three situations as follows:
situation 1: no sending of the downlink data packet is detected within the band;
situation 2: a loss of at least one downlink data packet is detected within the band; and
situation 3: reception of the first data packet is failed within the band.

19. The method according to claim 9, wherein the state symbol “DTX” in the state set represents that the UE detects occurrence of at least one of three situations as follows:
situation 1: no sending of the downlink data packet is detected within the band;
situation 2: a loss of at least one downlink data packet is detected within the band; and
situation 3: reception of the first data packet is failed within the band.

20. The method according to claim 9, wherein a state “NAK” in the state set represents that the UE detects occurrence of at least one of three situations as follows:
situation 1: no downlink data packet is detected for all of the CC within the band;
situation 2: there is a loss of the downlink data packet of at least one CC within the band; and
situation 3: reception of at least one data packet is failed within the band.
